(19) United States
(12) Patent Application Publication
(10) Pub. No.: US 2009/0200350 A1
(43) Pub. Date: Aug. 13, 2009

(54) Truck tool box and hinge system

(75) Inventors: Steven Dale Brallier, Rogersville, MO (US); Brian Gene Sharp, Rogersville, MO (US); Jason Dale Hutchens, Springfield, MO (US); James Gerard Quintus, Springfield, MO (US)

Correspondence Address: KANG INTELLECTUAL PROPERTY LAW, LLC, 214 ELM STREET, SUITE 106, WASHINGTON, MO, 63090, US

(73) Assignee: E. D. Industries, Inc., Rogersville, MO (US)

(21) Appl. No.: 12/069,060

(22) Filed: Feb. 7, 2008

(51) Int. Cl. B60R 9/06; B60R 27/00

(52) U.S. Cl. 224/404; 16/223

(57) ABSTRACT

The invention is a truck tool box that is attached to the bed of a pickup truck. The tool box is attached using brackets, a hinge system, and a latch system that allows a user to unlatch the tool box and swing it to the user.

### CROSS-REFERENCE TO RELATED APPLICATIONS

Not Applicable.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to tool boxes and, more specifically, to a tool box that can be mounted to the bed of a truck.

2. Related Art

Prior tool boxes have been mounted to the bed of a truck. Some tool boxes have often been extremely large, and consequently have removed a great deal of usable space from the bed area. Other tool boxes are located in a position that makes access extremely difficult. Yet other tool boxes are fixed in a single position.

All of the present tool boxes that are mounted in the bed of a truck have advantages and disadvantages, but there is a need in the art to provide maximize usable space, and still provide ease of access.

### SUMMARY OF THE INVENTION

The invention is a truck tool box that is mounted in a bed of a truck. The tool box is mounted using a truck bracket, and a first and second mating hinge members connecting the box plate to the truck bracket. There is preferably provided a box plate for attaching the first mating hinge member. The tool box is adapted to the shape of the wheel well of the truck, and is further adapted to provide clearance with the bed of the truck to permit a swinging action of the tool box.

In the primary embodiment, the first mating hinge member may be male and the second hinge member may be female. In an alternate embodiment, the first mating hinge member may be female, and the second mating hinge member male. In a further alternative embodiment, the first mating hinge member may be both male and female, with the second mating hinge member being oppositely female and male.

There are a number of important innovations with the truck tool box itself. The first and second body portions of the truck tool box are each provided with an exterior seam. This seam provides structural rigidity and allows for ease of manufacturing. The lid of the truck tool box provides functionality by exterior contouring, and a panel is bonded beneath the lid to provide structural rigidity. A latching mechanism is provided on the exterior of the box, and which is actuated by a spring biased pull rod that runs along the bottom of the tool box. The mate for the latching mechanism may be provided on the truck bracket or on the truck. A small tray may be disposed in the shallow portion of the tool box for providing a light.

It is important to the invention to control the dimension of the hinge pivot area to ensure proper swinging action of the tool box. Accordingly, the hinge pivot area is defined on one side as two inches plus the distance between the lightwell to the bed side, and defined on the other side as five inches from the tailgate forward.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevated view of the truck tool box of the present invention installed in a truck bed in a latched position;

FIG. 2 is an elevated view of the truck tool box of FIG. 1, wherein the tool box is in a non-latched position;

FIG. 3 is a plan left side view of the truck tool box of the present invention;

FIG. 4 is a plan right side view of the truck tool box of the present invention;

FIG. 5 is a plan rear end view of the truck tool box of the present invention;

FIG. 6 is a plan bottom view of the truck tool box of the present invention;

FIG. 7 is a top plan view of the truck tool box of the present invention;

FIG. 8A is a bottom elevated view of the bottom portion of the truck tool box of the present invention, wherein the hinge system is attached at the rear of the truck tool box;

FIG. 8B is a bottom elevated view of the bottom portion of the truck tool box of an alternate embodiment of the present invention, wherein the hinge system is attached is attached at the side of the truck tool box, and wherein a Bowden cable is used instead of a rod as a longitudinal member;

FIG. 9 is a rear elevated assembly view of the truck tool box of the present invention wherein the male hinge pins are disposed on the truck bracket;

FIG. 10 is a rear elevated assembly view of an alternate embodiment of the present invention wherein the male and female hinge members are equally shared between the truck bracket and the box bracket;

FIG. 11 is a rear elevated assembly view of another alternate embodiment of the present invention wherein the male hinge pins are disposed on the box bracket;

FIG. 12 is a rear elevated assembly view of the truck tool box of the present invention;

FIG. 13 is a rear elevated assembly view of an alternate embodiment of the truck tool box of the present invention;

FIG. 14 is a partial top plan view that defines the hinge pivot area area for the truck tool box of the present invention;

FIG. 15 is a partial top plan view of the truck tool box in a latched position, and the truck bed hinge pivot area; and

FIG. 16 is a partial top plan view of the truck tool box in an unlatched position, and the truck bed hinge pivot area.

### DETAILED DESCRIPTION OF THE PREFERRED EMBODIMENTS

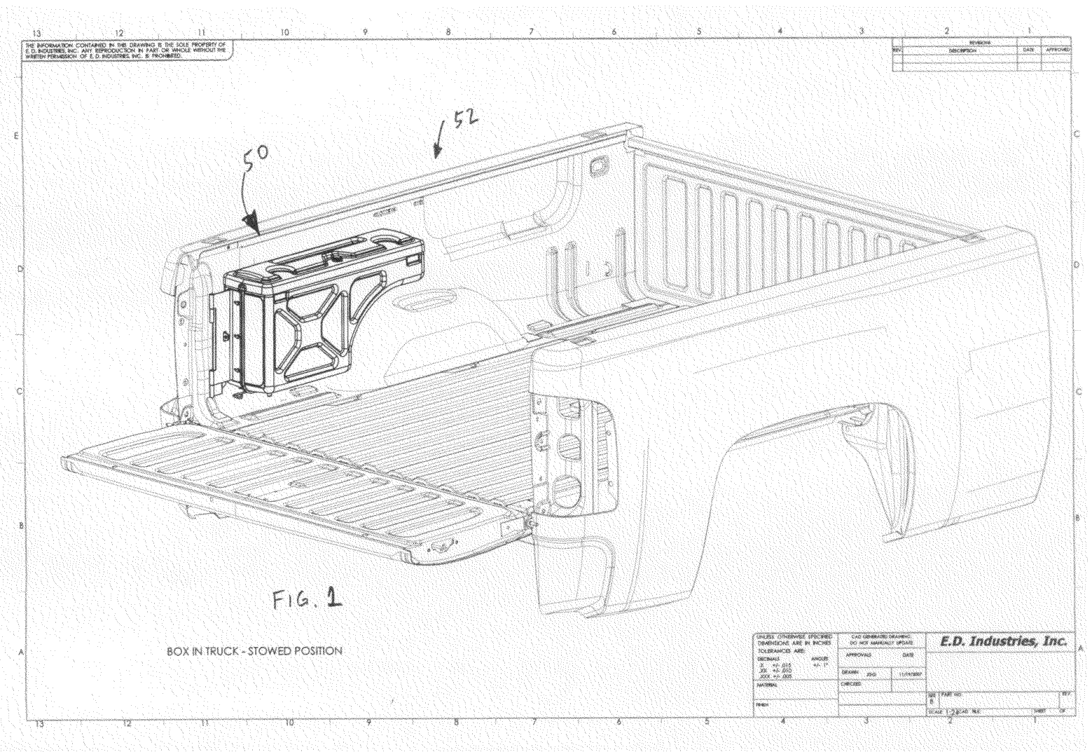

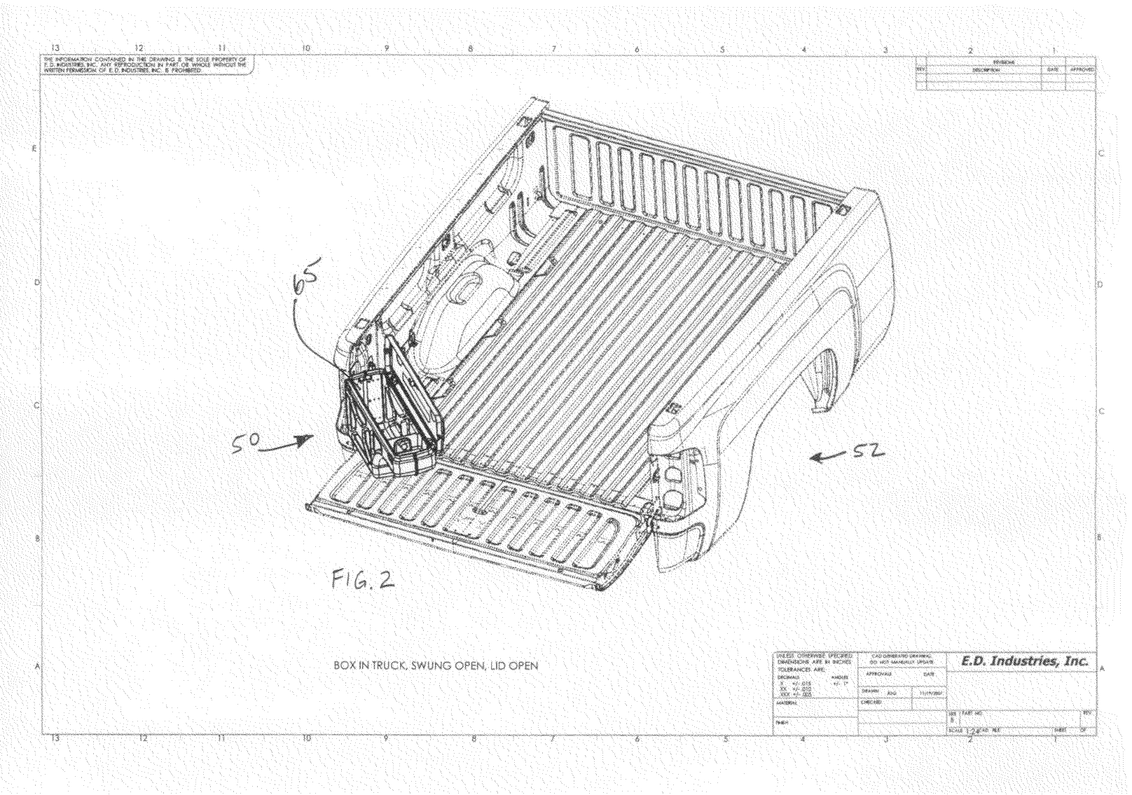

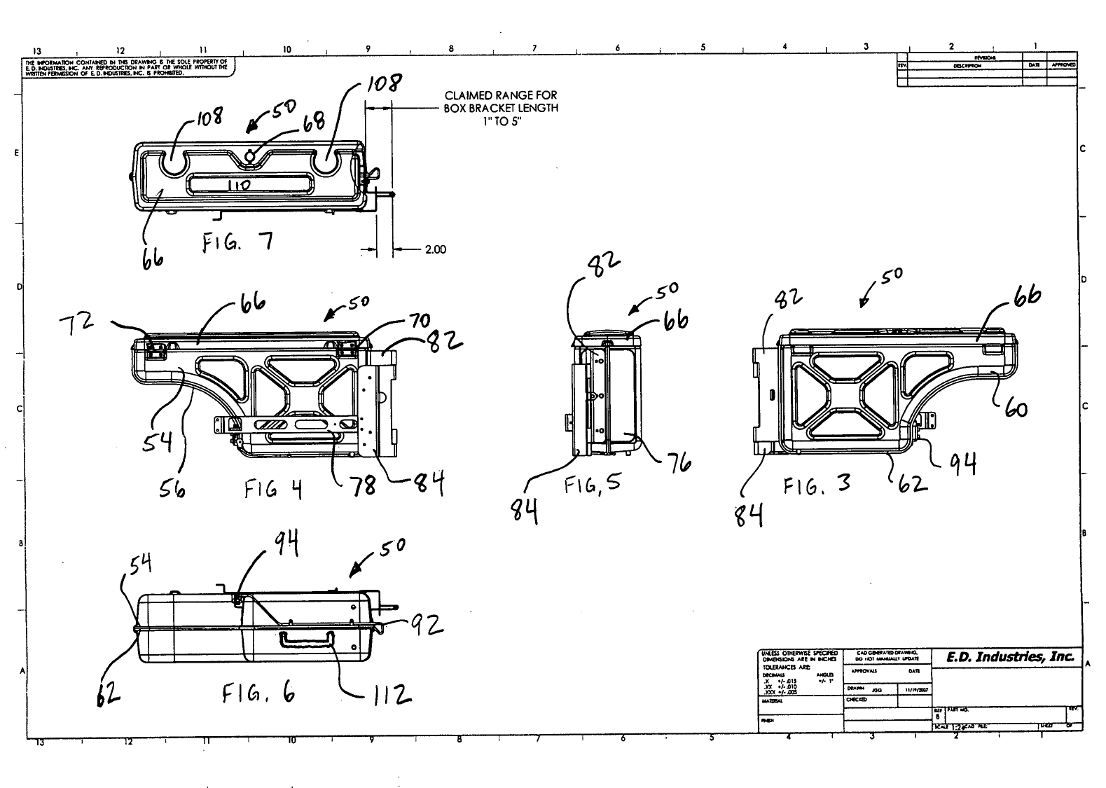

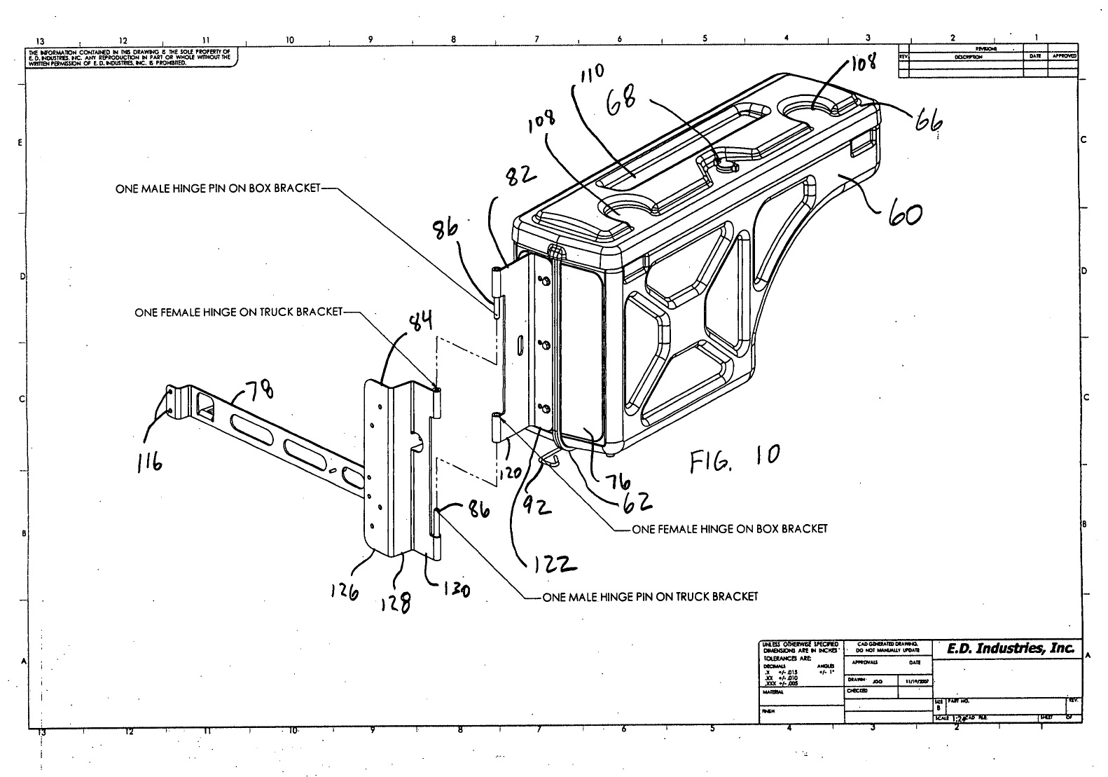

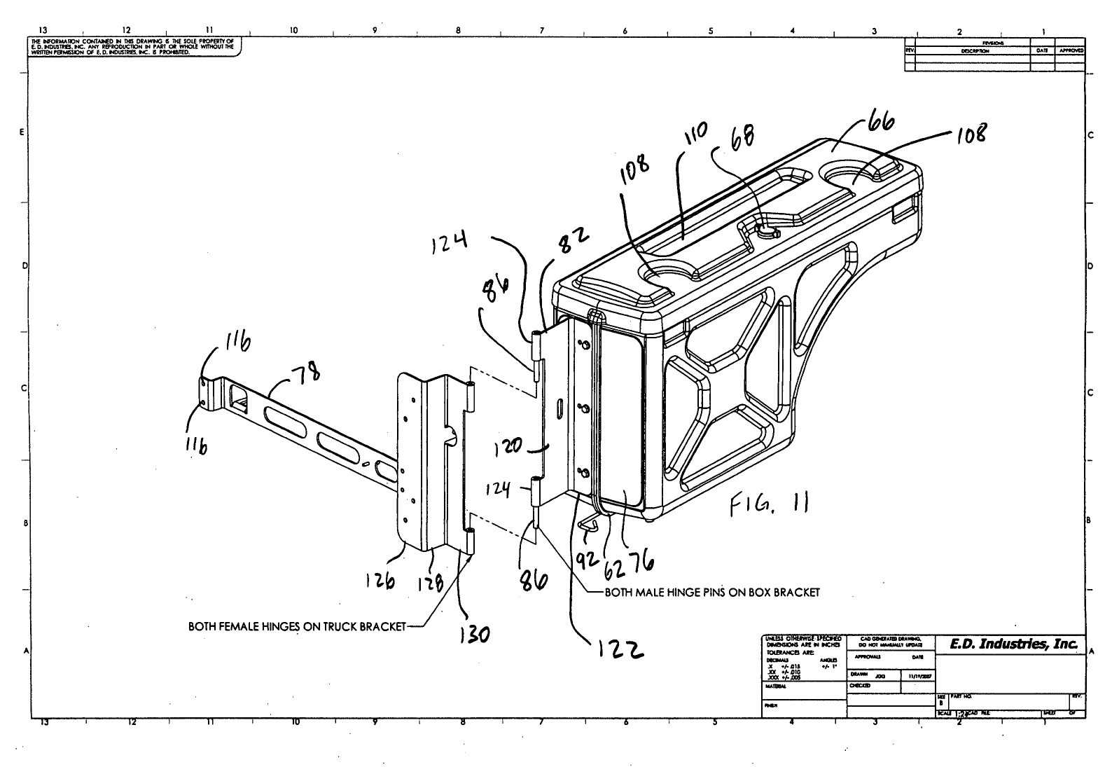

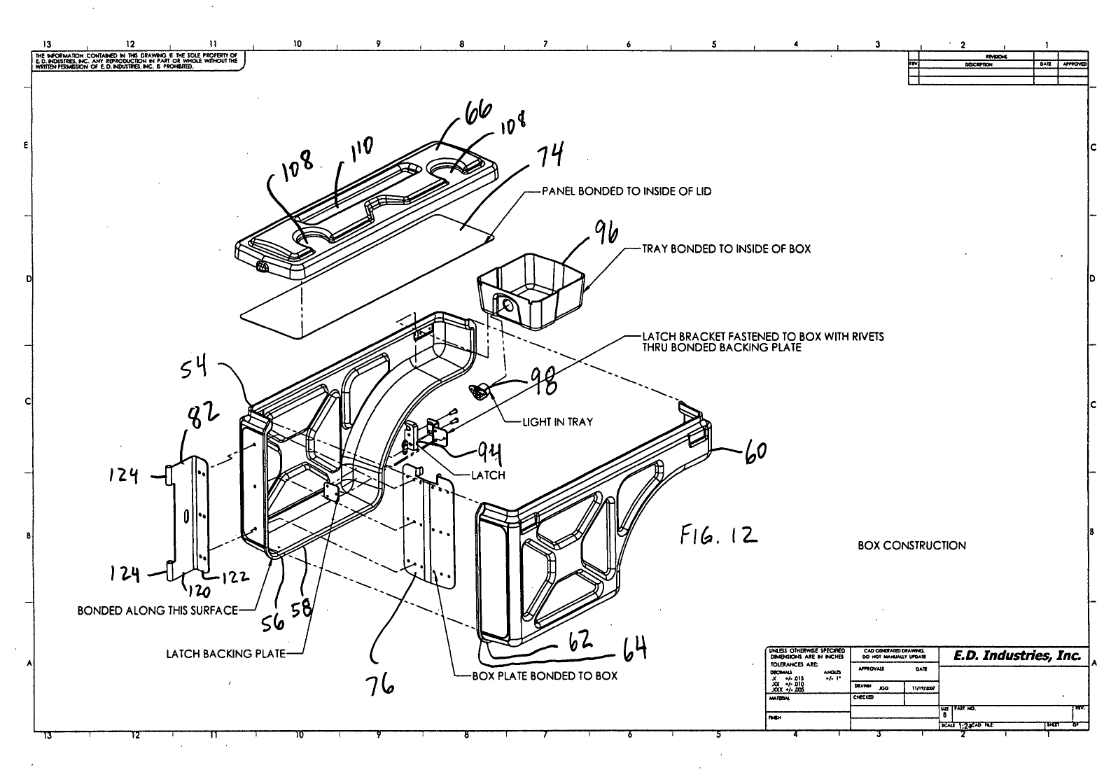

The following description of the preferred embodiment(s) is merely exemplary in nature and is in no way intended to limit the invention, its application, or uses. As shown in the drawings, according to FIGS. 1-13, there is shown a truck toolbox, generally at 50 installed in the bed, generally at 52, of a truck. FIG. 1 shows toolbox 50 in a latched position, and FIG. 2 shows toolbox 50 in an unlatched position.

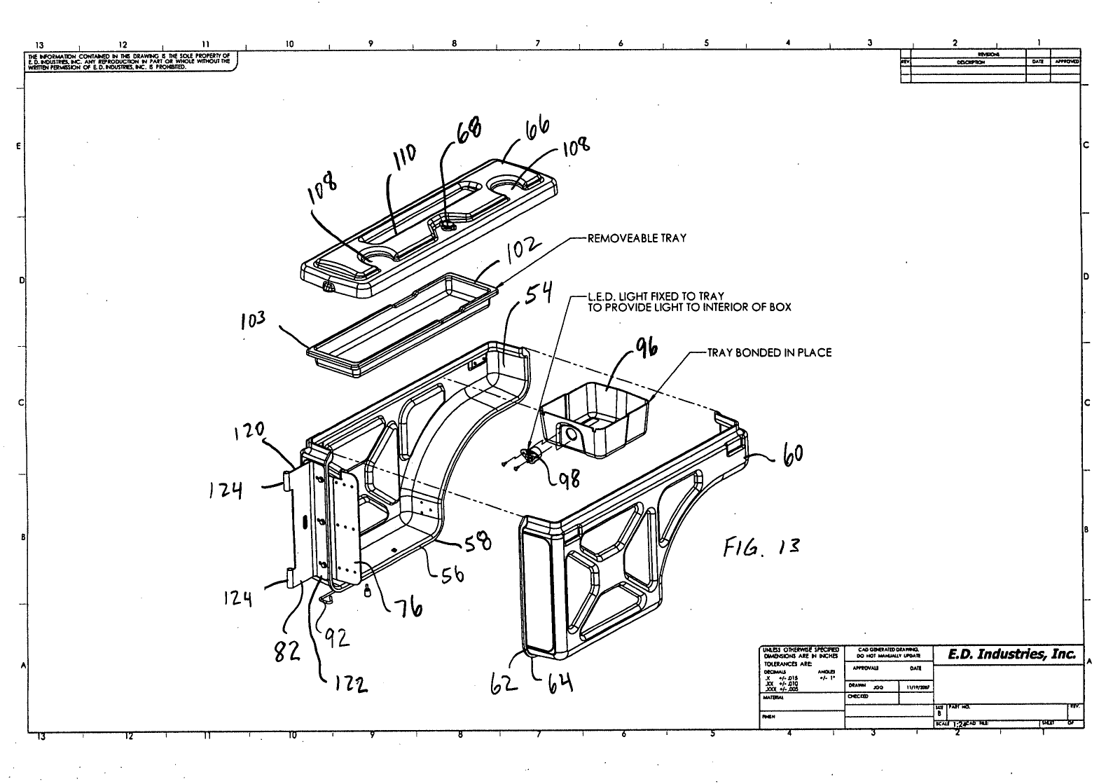

Truck tool box 50 has first body portion 54 shown with first exterior seam 56, having first rectangular area 58. Similarly, truck tool box 50 has second body portion 60 with second exterior seam 62, having second rectangular area 64. As best shown in FIG. 12 and FIG. 13, first rectangular area 58 of first exterior seam 56 of first body portion 54 is joined with second rectangular area 64 of second exterior seam 62 of second body portion 60. Thus joined, first body portion 54 and second body portion 60 defined interior space 65.

Truck tool box 50 is also provided with a lid 66. A lock 68 is provided on lid 66. Lid 66 is joined to first body portion 54 via first lid hinge member 70 and second lid hinge member 72. Preferably, lid 66 is reinforced by lid panel 74 which provides structural rigidity and integrity. Lid 66 is also provided with cup holder recess 108 and rectangular recess 110 for depositing small objects such as screws, nails, or nuts.

The joinder of first body portion 54, second body portion 60, and lid 66 form the basic tool box 50. As shown in the drawings, the joinder of these elements provide a tool box 50 having a front, rear, right side, left side, top, and bottom. At the rear of tool box 50, a box plate is preferably attached. To the bed 52 of the truck, a truck bracket 78 is attached. Then, between box plate 76 and truck bracket 78 is placed a first mating hinge member 82, alternately referred to as “L-shaped box bracket,” and second hinge mating member 84. As shown more specifically in FIG. 9-11, male pins 86 may be disposed on second hinge mating member 84, or alternately on each of L-shaped box bracket 82 and second hinge mating member 84, or alternately on L-shaped box bracket 82 alone.

Thus, attached to the bed 52 of the pickup truck, tool box 50 may assume a latched or unlatched position. To accomplish this, spring-biased male latch portion 94 is disposed on the front of truck tool box 50, and female latch portion 80 may be disposed on truck bracket 78. In an alternate embodiment, female latch portion 80 may be disposed on the bed 52 of the pickup truck (not shown). Longitudinal member 92, alternately referred to as rod 92 or as Bowden cable, is disposed along the bottom of truck tool box 50. At one end, rod 92 pulls spring-biased male latch portion 94 to release it from female latch portion 80. The other end of rod 92 extends beyond the rear plane of tool box 50 in ergonomic accessible manner, preferably a hook shape. Spring-biased male latch portion 94 is adapted to close with female latch portion 80 upon the application of sufficient force.

It will be appreciated that L-shaped box bracket 82 has a first body portion 120 and a second body portion 122. Said second body portion 122 of said L-shaped box bracket 82 is adapted for attachment to truck tool box 50 while the first body portion 120 has a first mating hinge connector 124. Second mating hinge connector 84 has a first body portion 126 attached to truck bracket 78, a second body portion 128 disposed at an angle to the first body portion 126, and a third body portion 130 disposed at an angle to the second body portion 128. The third body portion 130 of second hinge mating member 84 is adapted to mate with first mating hinge connector 124 of L-shaped box bracket 82.

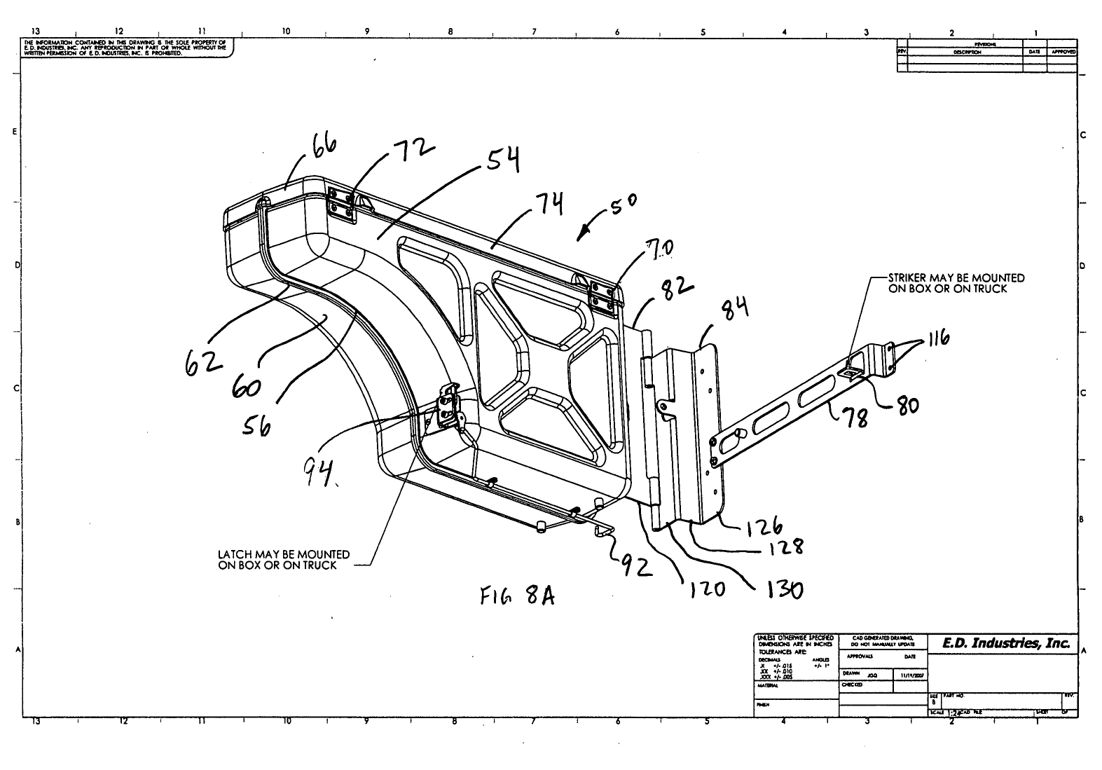

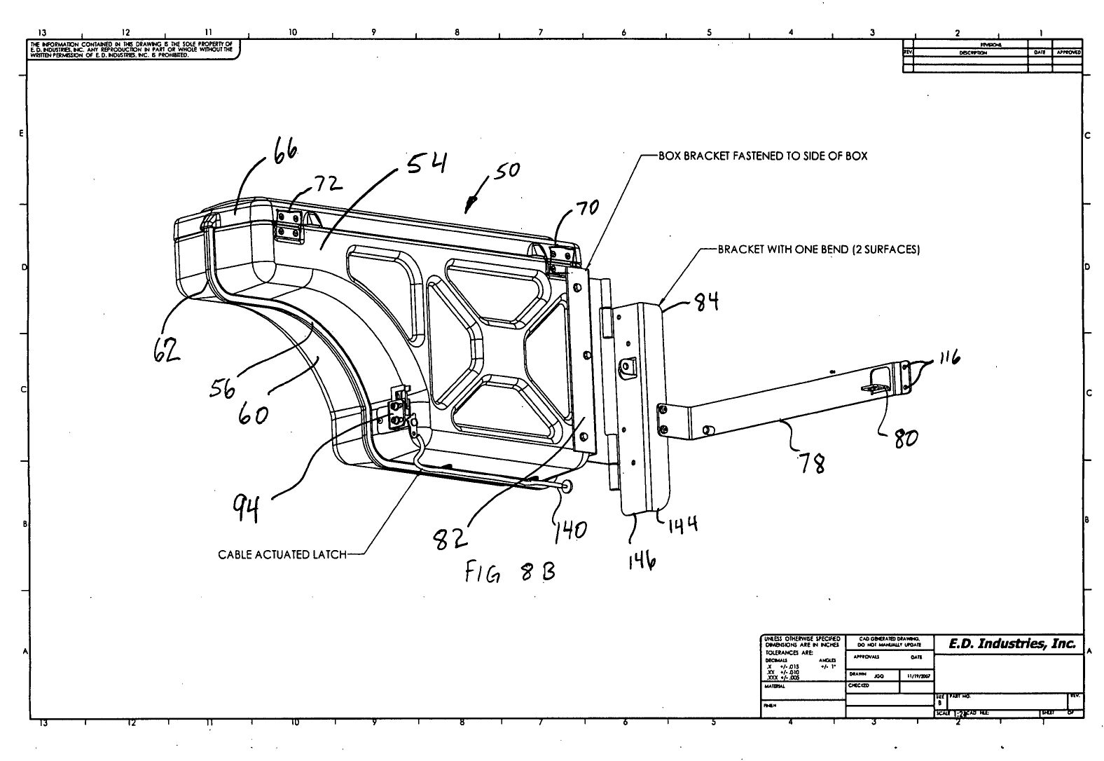

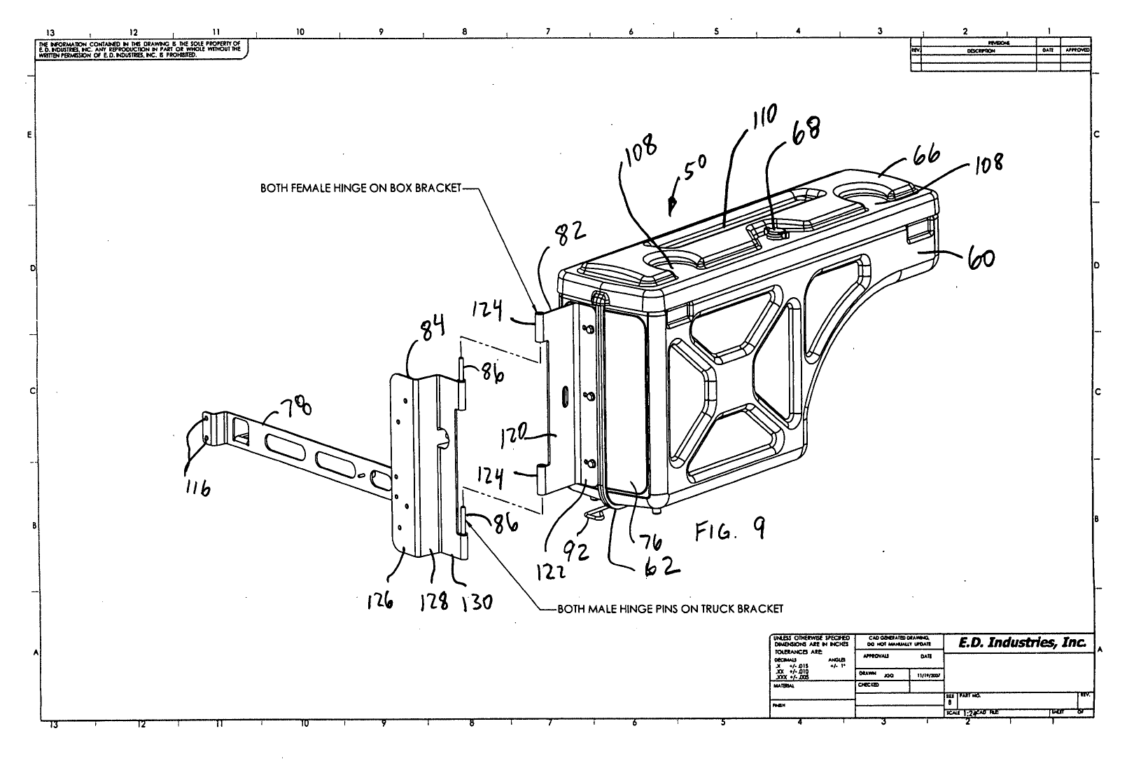

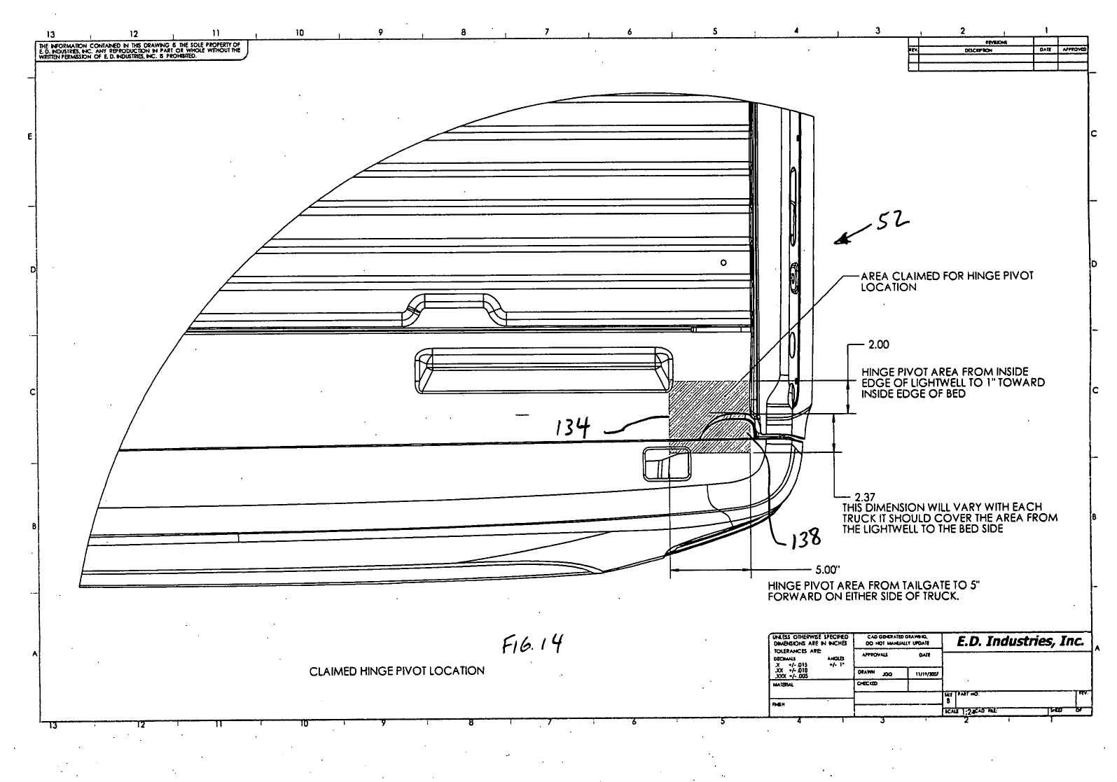

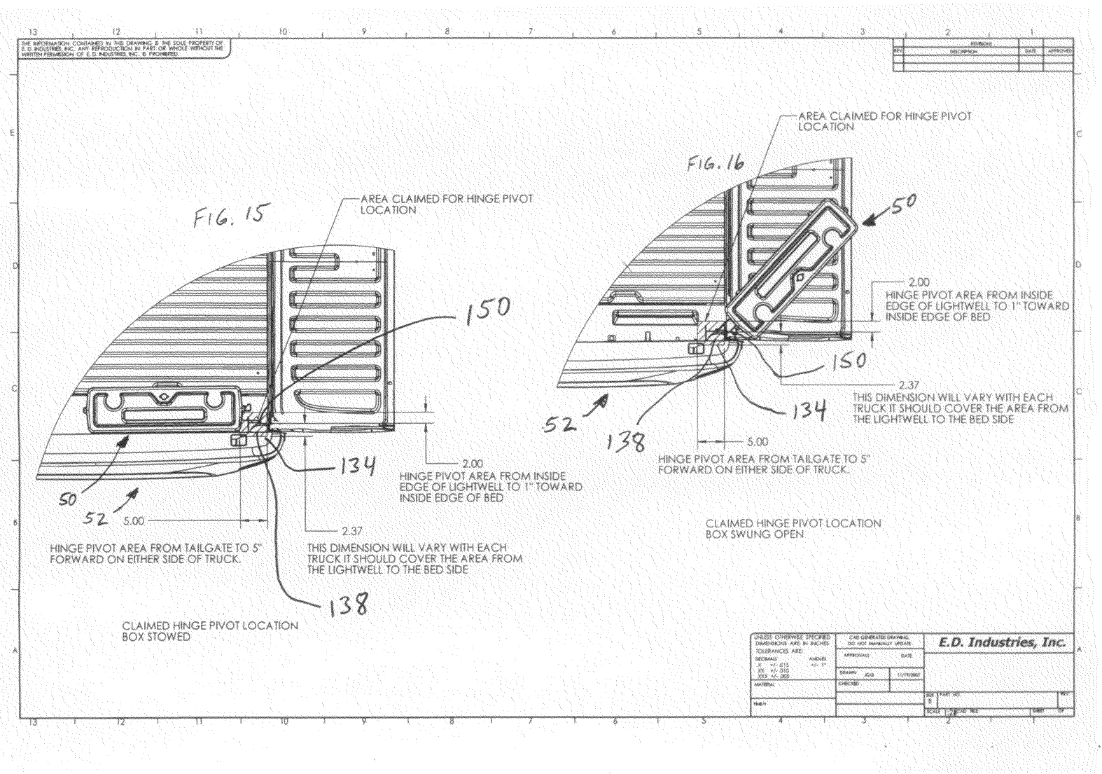

The geometric details regarding L-shaped box bracket 82 and second hinge mating member 84 are important because the hinge and swinging action of truck tool box 50 will not be successful unless sufficient clearance is provided from the lightwell 138 at the rear of the bed 52. In order to have sufficient clearance from the lightwell 138, there is defined a hinge pivot area 134 best shown in FIGS. 14, 15 and 16. It is critical to the operability and utility of the invention that the hinge pivot point 150 be located in the area defined by the hinge pivot area 134. The hinge pivot point is the point where the second mating hinge connector 84 mates with first mating hinge connector 124 of box bracket 82. In particular, this hinge pivot area 134 is defined on one side as the dimension of five inches along the inside sidewall of the truck bed from the tailgate edge forward to the cab, and on the other side as the dimension of two inches from the outer edge of the lightwell 138 measured away from the nearest truck bed inside sidewall, minus the area occupied by the lightwell 138 itself. As clearly seen in FIGS. 15 and 16, the hinge pivot point 150 in the present invention must be located within the hinge pivot area 134 in order to have an appropriate swing action, for convenience of unlatching, and to avoid damaging the lightwell 138. Accordingly, from FIG. 8A, both the L-shaped box bracket 82 and the second mating hinge connector 84, and their respective body portions, 120, 122, 126, 128, 130, respectively, are specifically adapted and dimensioned such that the hinge pivot point 150 is located within the hinge pivot area 134, which provides clearance from lightwell 138. In the alternate embodiment of FIG. 8B, both the box bracket 82 and the second mating hinge connector 84 are likewise adjusted in the various dimensions of body portions 144 and 146 in order to place the hinge pivot point 150 within the hinge pivot area 134, and guaranteeing that there will be no interference in movement of the hinge system or from the truck tool box 50 with lightwell 138.

In the alternate embodiment of FIG. 8B, there is shown a longitudinal member 144 alternately referred to as Bowden cable 144. Bowden cable 144 may be used instead of rod 92 as a different longitudinal member 144. In addition, it can be seen in this alternate embodiment that second mating hinge member 84 can have only two body portions, first body portion 144 and second body portion 146. More importantly, it can be seen that box bracket 82 is not L-shaped as the embodiment of FIG. 8A and is attached to the side of truck tool box 50, instead of being attached at the rear of truck tool box 50 (shown in the primary embodiment in FIG. 8A).

A tray 96 may be bonded within interior space 65 of truck tool box 50. This tray 96 is preferably provided with a light 98. In an alternate embodiment, a removable tray 102 may further be provided. Such removable tray has a lip 103 disposed in circumference and which rests on contours provided within interior space 65.

In operation, the truck tool box 50 assumes the position of FIG. 1, a latched position. A user inserts his or her finger into the hook provided in rod 92 and pulls. Pulling rod 92 longitudinally releases spring-biased male latch portion 94 from female latch portion 80, and the tool box swings according to L-shaped box bracket 82 and second hinge mating member 84 towards the user. Importantly, because the hinge pivot point 150 is located within hinge pivot area 134, the truck tool box 50 swings without any touching of the lightwell 138 by either the truck tool box 50 or the hinge system. Then the user may open lid 66 and access interior space 65, as shown in FIG. 2. Should the user need to take truck tool box 50 out of the bed 52 of the truck, the user may lift the tool box 50 (best shown in FIG. 9) and carry truck tool box 50. For convenience, a handle 112 is provided (FIG. 6).

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, it is understood that the various body portions 54, 60 may be made in a variety of shapes and colors for aesthetics. In addition, the lid 66 may be provided with a translucent top and be made to glow via light provided on the other body side. Additional magnetic pads, not shown, may be introduced in order to facilitate storage of tools or hardware. Thus, the breadth and scope of the present invention should not be limited by any of the above-described exemplary embodiments, but should be defined only in accordance with the following claims appended hereto and their equivalents.

What is claimed is:

1. A truck tool box comprising:
a first body portion having a first exterior seam defining a first rectangular area;
a second body portion having a second exterior seam defining a second rectangular area, said second body portion being joined to said first body portion by joinder of said first rectangular area of said first exterior seam of said first body portion and said second rectangular area of said second exterior seam of said second body portion to define an interior space;
a lid; and
first and second lid hinge members connecting said lid to one of said first and second body portion members.

2. A truck tool box according to claim 1, wherein said truck tool box comprises a front, a rear, a top and a bottom, further comprising,
a truck bracket adapted for attachment to the side wall of a truck bed; and
a first mating hinge member and a second mating hinge member, wherein said first hinge member mates with said second hinge member, and wherein said first hinge member is connected to the rear of said truck tool box, said second hinge member is connected to said truck bracket.

3. A truck tool box according to claim 2, further comprising a box plate disposed between said first mating hinge member and said rear of said truck tool box.

4. A truck tool box according to claim 2, further comprising:
a male latch portion disposed on one of said bottom and front of said tool box;
a longitudinal member disposed along said bottom of said tool box, in communication with said male latch portion
a female latch portion adapted to mate with said male latch portion; and
wherein a longitudinal movement of said longitudinal member is adapted to disengage said male latch portion from said female latch portion.

5. A truck tool box according to claim 1, further comprising:
a lid; and
a first and second lid hinge members each connecting one of said first and second body portions and said lid.

6. A truck tool box according to claim 5, further comprising:
a panel attached to said lid; and
a lock seated on said lid, and in communication with one of said first and second body portions.

7. A truck tool box according to claim 1, further comprising:
a tray permanently disposed in said tool box, said tray being provided with a light source.

8. A hinge system for accessing a truck tool box comprising:
a truck bracket having a first end and a second end, one of said first and second ends being adapted for attachment to a sidewall of a truck bed;
an L-shaped box bracket having a first body portion and a second body portion, said second body portion being adapted for attachment to a truck tool box and said first body portion having a first mating hinge connector; and
a second mating hinge connector having a first body portion attached to said truck bracket, a second body portion disposed at an angle to said first body portion, and a third body portion disposed at an angle to said second body portion, said third body portion being adapted to mate with said first mating hinge connector of said L-shaped box bracket.

9. A hinge system for accessing a truck tool box according to claim 8, wherein said second body portion of said L-shaped box bracket is adapted to provide a hinge pivot point located within a hinge pivot area to provide clearance from a lightwell at the rear of a truck bed.

10. A truck tool box assembly comprising:
a first body portion having a first exterior seam defining a first rectangular area;
a second body portion having a second exterior seam defining a second rectangular area, said second body portion being joined to said first body portion by joinder of said first rectangular area of said first exterior seam of said first body portion and said second rectangular area of said second exterior seam of said second body portion, the joinder defining an interior space and a front, rear, left side, and right side of said truck tool box assembly;
a lid; and
first and second lid hinge members connecting said lid to one of said first and second body portion members;
a single hinge assembly connected to only said rear of said truck tool box assembly.

11. A hinge system for a truck tool box comprising:
a truck bracket having a first end and a second end, one of said first and second ends being adapted for attachment to a sidewall of a truck bed;
a box bracket adapted for attachment to a tool box and having a first mating hinge connector;
a second mating hinge connector adapted to mate with said first mating hinge connector of said box bracket, said mating location defining a hinge pivot point;
wherein said hinge pivot point is located within a hinge pivot area that avoids interference with a lightwell located within a truck bed.

11. A hinge system for a truck tool box according to claim 11, wherein said box bracket is attached to the rear of said tool box.

12. A hinge system for a truck tool box according to claim 11, wherein said box bracket is attached to the side of said tool box.
